(19) United States
(12) Patent Application Publication
(10) Pub. No.: US 2021/0176037 A1
(43) Pub. Date: Jun. 10, 2021

(54) ENCRYPTING DATA

(71) Applicant: Hewlett-Packard Development Company, L.P., Spring, TX (US)

(72) Inventors: Joshua Serratelli Schiffman, Bristol (GB); Thalia May Laing, Bristol (GB); Gaëtan Wattiau, Bristol (GB)

(73) Assignee: Hewlett-Packard Development Company, L.P., Spring, TX (US)

(21) Appl. No.: 17/047,291

(22) PCT Filed: Aug. 28, 2018
(86) PCT No.: PCT/US2018/048347

§ 371 Date: Oct. 13, 2020

(51) Int. Cl. H04L 9/06; H04L 9/32; G09C 1/06; G06F 3/12

(52) U.S. Cl. CPC H04L 9/0618; H04L 9/3242; G06F 3/1238; G06F 3/1222; G06F 3/1212; G09C 1/06

(57) ABSTRACT

There is disclosed a method for encrypting data representing a rendering task, the method comprising segmenting the data to form multiple variably sized segments, wherein each segment comprises a payload, and a footer portion comprising at least a footer size section indicating the size of a footer encoding the size of a subsequent segment, and encrypting each segment using data associated with that segment and the rendering task.

### BACKGROUND

Authenticated encryption is used to protect print job data confidentiality and integrity. Bulk encryption of a print job can be used, where a client can encrypt an entire job before sending it to a printer, then the printer can decrypt and verify the entire job before printing.

### BRIEF DESCRIPTION OF THE DRAWINGS

Various features and advantages of certain examples will be apparent from the detailed description which follows, taken in conjunction with the accompanying drawings, which together illustrate, by way of example, a number of features, and wherein:

FIG. 1 shows the structure of a PRinterMAC segment according to an example;

FIG. 2 shows PRinterMAC encryption according to an example;

FIG. 3 shows an encryption process according to an example;

FIG. 4 shows a whole encryption process according to an example;

FIG. 5 shows a decryption process according to a example;

FIG. 6 shows a method for encrypting data representing a rendering task according to an example; and

FIG. 7 shows a processor associated with a memory comprising computer readable instructions for executing a method for encrypting data representing a rendering task according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Authenticated encryption schemes both encrypt data for confidentiality and provide a message authentication code (MAC) to verify data integrity. A MAC tag can be computed over the whole decryption process before it can be validated. Thus, a receiver may wait to receive and process an entire ciphertext before checking the authenticity of the data. In a printing context, the delay to verify delays the time to print until the entire job is decrypted and verified. For large jobs, this delay can have significant impact on first page out (FPO) performance, which may lead to users disabling encryption or using a less secure mode. This problem is also relevant to any data flows to and from printers (e.g. scanning) that are processed immediately.

A data segmentation scheme called interMAC is known that inserts MAC tags into a data stream to protect against adversaries that could re-order, truncate, or otherwise trick the recipient into receiving infinitely long messages. For example, interMAC uses a fixed segment size, agreed upon by both parties ahead of time, to achieve boundary hiding of the segment size from outside parties. However, this size may be discoverable since a common value may be used for performance. In addition, the interMAC scheme assumes that the data is a multiple of the segment size and can use padding of the data if it is not.

This disclosure describes a construction called “PRinterMAC” that splits a print job into smaller segments that can be transmitted and decrypted independently and immediately. An encryption and decryption function are described. There is provided a method for applying authenticated encryption to large print jobs that enables immediate transmission at the sender and immediate processing at the receiver after the first segment is processed. The construction breaks the data into smaller segments (potentially of varying size) and applies authenticated encryption to the segments individually.

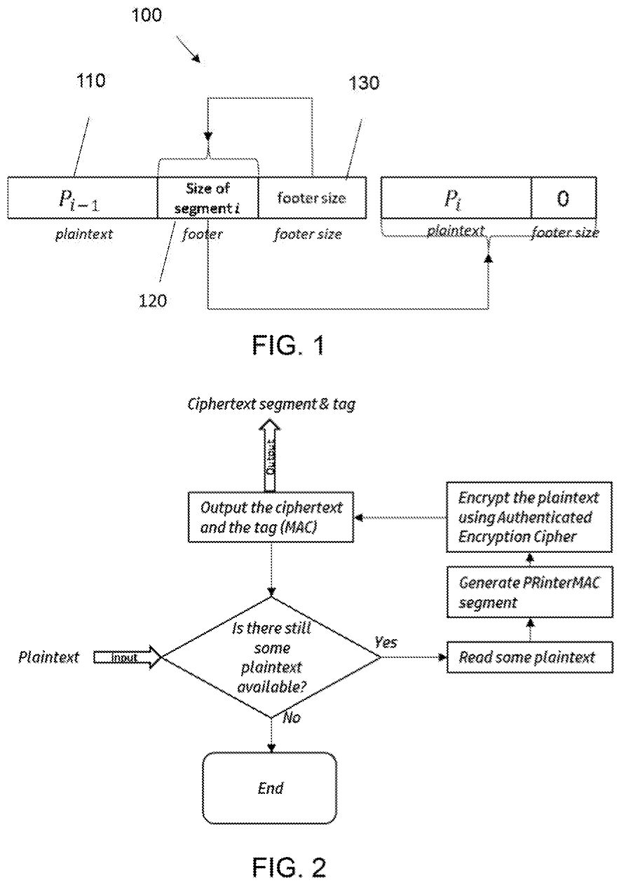

FIG. 1 shows the structure of, a PRinterMAC segment according to an example. A segment may comprise a payload section 110 and a footer portion 120, 130. As shown, a segment 100 may comprise: the payload or plaintext section 110; a footer section 120; and a footer size section 130. The footer portion may comprise a footer section 120 and a footer size section 130. The plaintext section (Pᵢ₋₁) 110 contains the data to be encrypted. The footer section 120, if present, contains the size of the next segment (i). The footer size section 130 contains the size of the footer section 120 or other metadata.

The footer size section 130 can be fixed so that a recipient knows how much data to parse, for example, a 1-byte long section. This value is used to encode information such as: the size of the next segment (i); whether the stream is finished; whether a logical portion is finished; or whether the next segment (i) is a dummy value.

According to an example, a first or initialization segment can be used to bootstrap the data stream. For example, the initialization segment can be a fixed size segment that contains no plaintext data but is used to indicate the size of the second segment.

Each segment 100 comprises a footer 120 that indicates the size of the next segment to process or whether the data stream has finished. The sender can start the stream by sending a fixed size initialization segment to indicate to a recipient how large the first segment will be. As each segment 100 is received, the recipient may decrypt and authenticate the segment and immediately process (e.g. print) the data.

According to example, the segment size can be tuned to provide improved performer) e.g. smaller segments initially and larger later),

According to an example, a strategy can be applied to obfuscate the boundary of the data's contents such as randomizing segment size, inserting dummy segments, or adjusting segments on a contextual level (e.g., per page, per job). This provides boundary hiding which can be useful when knowledge about the size of the data may be meaningful and where encryption alone cannot hide such metadata. According to an example, PRinterMAC enables the security property of boundary-hiding for practical use cases. As such, segments can be variably sized and their respective sizes can be generated independently, i.e. that is for any [symbol] and [symbol] the size of segmentᵢ is independent from the size of segmentᵢ.

PRinterMAC can generate segments from the plaintext and can encrypt and send these segments separately. FIG. 2 describes PRinterMAC encryption according to an example. Each segment may be encrypted using the same key but with different initialisation vectors (IV) and/or different additional authenticated data (AAD). For example, the PRinterMAC construction may use a compound initialization vector construction to provide protection against an adversary that may attempt to re-order the segments, truncate the message, or replay the data.

According to an example, initialization vectors may be generated from three values including a nonce, a message counter and a segment counter. A nonce may relate to a random value that does not change for a session. A message counter may relate to a counter that is incremented after each logical portion or message, i.e. the message counter is incremented after a logical portion is completed. A segment counter may relate to a counter that is incremented after each segment, i.e. each segment may increment the segment counter. A logical portion may be defined as an entire job. Thus, multiple jobs can be included in a single stream and the printer can increment the counter after each one is received. Alternatively, a printed page can act as a logical portion.

According to an example, for segment the initialization vector can be generated as: [symbol] , where | is the concatenation operation.

According to an example, additional authenticated data relates to a value that is authenticated but not encrypted. The additional authenticated data may be taken as an input to generate a MAC tag. Without the correct additional authenticated data, the ciphertext may not be authenticated. For example, for segment the additional authenticated data can be generated by:

[symbol]

.

Generating initialisation vectors and additional authenticated data mitigates attacks that replace one segment with another, since the initialisation vectors and additional authenticated data for two different segments are different. Consequently, the decryption would not otherwise succeed in such an attack.

According to an example, the initialisation vectors and the additional authenticated data are implied by the PRinterMAC construction such that they are predictable by the receiver. As such, the initialisation vectors and the additional authenticated data may not be sent with the ciphertext.

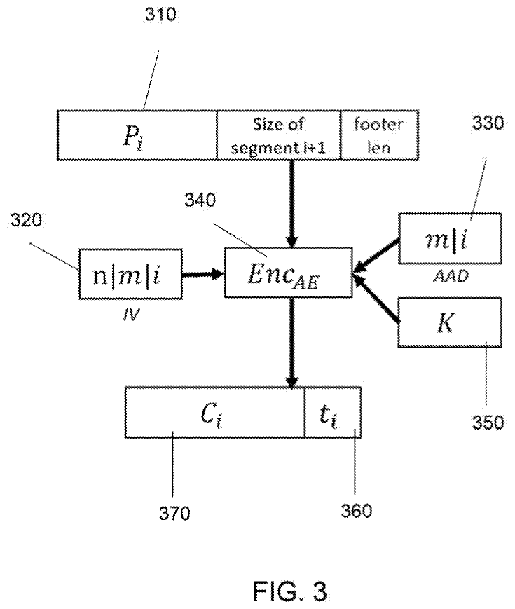

The encryption process will now be described according to the example of FIG. 3. A single segment may be encrypted. The segment counter value i may be incremented by one for each segment. Inputs to the encryption process may comprise:
plaintext data 310 (can be any size) (P [symbol] for any N>0
the random nonce, n, 320,
the message counter, m, 330,
an authenticated encryption cipher AE, 340, and
a random key for this cipher K, 350.

A MAC tag 360, tᵢ is associated to the encrypted segment 370 or ciphertext segment cᵢ. When a segment is encrypted, the segment counter is incremented, then the next generated segment counter plaintext is taken and encrypted (Enc_{AE}) with the initialisation vectors (IV) and the additional authenticated data (AAD).

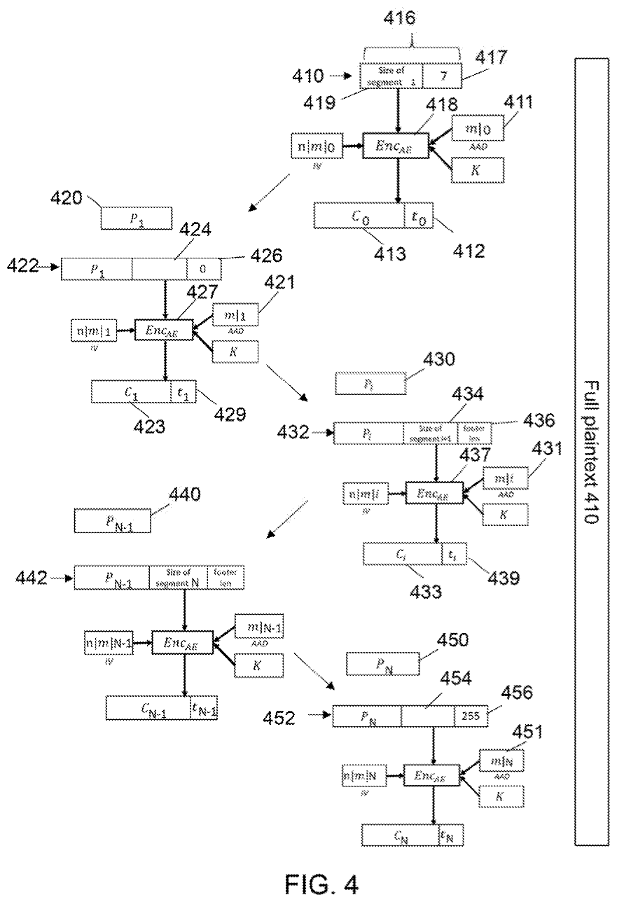

The whole encryption process is shown in FIG. 4 according to an example.

The rendering task may be represented by plaintext 410. The plaintext is, received as input and is split into N payloads or plaintext sections 420, 430, 440, 450 (of potentially differing sizes): P₁, P₂, . . . P_{N}. Each of the plaintext sections to be used for constructing N respective segments.

An initialization segment 410 (P₀) is formed first. The initialization segment 410 comprises the initialisation vectors. The initialisation segment may, for example, comprise an eight-byte footer portion 416 comprising a one-byte footer size section 417. As shown, this footer size section 417 is defined to be a “7” in the initialization segment 410, which defines the length of the footer in the current segment 422 as seven-bytes long. The initialization segment 410 is encrypted using authenticated encryption 418 with the message counter, m, and segment counter, i, 411 input as associated data. A MAC tag 412, (t₀) is associated to the encrypted segment 413 (C₀) or ciphertext segment.

According to an example, the footer size section for each and every segment may be one-byte size.

According to an example, the footer 419 (of the same segment) may be empty if the footer size section has an entry of “0”, meaning that the next segment is the same size as the current segment. Similarly, if the footer size section has an entry of “255”, the footer (of the same segment) is empty, meaning that the current segment is the final segment and there is no next segment. In other cases, if the footer size segment is any other value (from 1 to 254), the footer section is not empty.

Now that the initialisation segment 410 has been encrypted, the segment counter value (i) is incremented. Then, the next (first) segment 422 for the generated segment counter value (i=1) is taken and encrypted (AE) with the initialisation vectors (IV) and the additional authenticated data (AAD).

To construct the first segment 422, the length of the subsequent plaintext section (Pᵢ) 430 (variable), the size of the footer 436 and the fixed-length footer size section (e.g. of one-byte) are considered. If Pᵢ 430 is the same size as the current plaintext section (P₁) 420, then the footer size section 426 (which may itself have a size of one-byte) can be marked as “0” and the footer section 424 will be empty (which is the case in the example shown here). The current plaintext section (P₁) 420, the empty footer section 424 and the “0” footer size section 426 are encrypted using authentication encryption 427. The encryption uses the message counter, m, and segment counter value, i, 421 (incremented by 1) as associated data. A MAC tag 429, (t₁) is associated to the first encrypted segment 423 (C₁) or ciphertext segment.

This encryption process continues to construct the subsequent, ith segment 432, considering the size of the subsequent N−1 segment 442. For example, if the subsequent plaintext section 440 (P_{N-}1) is the same size as the current plaintext section (Pᵢ) 430, the footer size section 436 is “0” and the footer section 434 is empty. However, if the subsequent plaintext section (P_{N-1}) 440 is a different size to the current plaintext section (Pi) 430, the footer size section 436 (associated with P_{N-1}) is defined to show how many bytes the footer is (this is how many bytes are required to define the size of P_{N-1}). The plaintext P_{N-1} 440, the footer section 434 (defining how long P_{N-1} is) and the footer size section 436 (defining how long the footer section is) are then all encrypted using authenticated data 437 (with the message and segment counter 431 as associated data). The encryption uses the message counter, in, and segment counter value, i, 431 (incremented by 1) as associated data. A MAC tag 439, (tᵢ) is associated to the ith encrypted segment 433 (C,) or ciphertext segment.

This encryption process continues until, finally, the last segment 452, P_{N}, is reached and there will be no subsequent segment. In this case, the footer size section 456 value may be “255”, indicating that this is the final segment 452 to be constructed, and the footer section 454 is empty. As before, the final segment 452 is encrypted using authenticated data with the message and segment counter 451 as associated data.

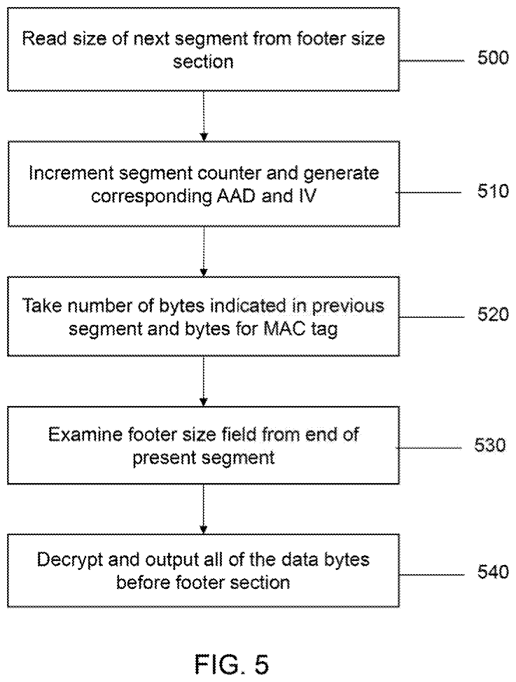

FIG. 5 shows a decryption process according to an example. Once the PRinterMAC encryption has been defined, the PRinterMAC decryption can occur where the receiver gets the initialization segment and decrypts it. For example, in block 500 the receiver reads the size of the next segment from the footer size section. Then, for each segment: at block 510 the receiver increments the segment counter and generates the corresponding AAD and IV; at block 520 the receiver takes the number of bytes indicated in the previous segment and bytes for the MAC tag; and at block 530 the receiver examines the footer size field from the end of the segment. The receiver then determines any metadata for processing the next segment For example, it could indicate that the length of the next segment, the size of the segment does not change, special handling behaviour (e.g. dummy segment) or this is the last segment. At block 540 all of the data bytes before the footer section is decrypted and outputted.

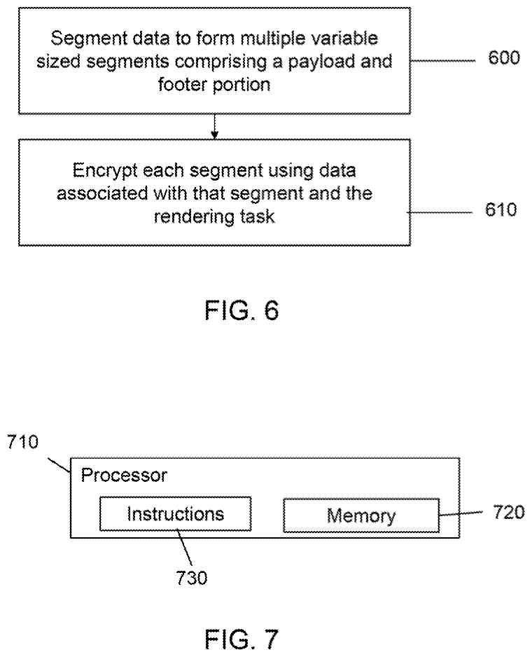

FIG. 6 shows a method for encrypting data representing a rendering task according to an example. The method may comprise segmenting the data to form multiple variably sized segments. Each segment may comprise a payload and a footer portion. The footer portion may comprise at least a fixed-length footer size section indicating the size of a footer encoding the size of a subsequent segment. The payload of a segment may be encrypted using data associated with that segment and the task.

According to an example, the PRinterMAC may be implemented using any authenticated encryption scheme such as AES-CCM, AES-GCM, and ChaCha20-Poly1305. The application may extend beyond sending data to a printer, for example, other applications may comprise:
Scanning data on a printer and sending it to a client for rendering
3D print data (3MF files)
Cloud print workflows that render the data before printing

According to an example, the logical portions may be defined as pages, paragraphs, 3D object layers, color channels, or other delineations that can be processed immediately upon receipt.

Per-packet or per-message encryption schemes may use a combination of encryption and authentication schemes that are subject to manipulation or lack efficiency, where some examples include SSH encryptions, IPsec ESP and AH protection, and encrypted sessions like TLS. The present disclosure improves MAC tag construction and adapts it to a printing context. This is achieved by eliminating negotiated segment lengths and padding. Various strategies for boundary hiding are provided, including randomization and context aware selection which allows for segments that can be fully processed on their own (such as a fully printable document page). The method provided defines an initialisation vector that works with the segment length strategy.

The PRinterMAC construction can reduce the ciphertext size under some selection of parameters, which improves the efficiency over MAC tag. This improves user experience of authenticated encryption which can otherwise cause noticeable slowdown to the printing experience and otherwise affects the perceived “first page out” (FPO) time and may lead to users disabling encryption. For example, a print job can be encrypted, but the process slows the print process considerably and affects the perceived first page out (FPO) time. In order to maintain confidentiality and integrity whilst improving FPO time, a job may be segmented into multiple segments, each having different sizes from one another in order to prevent boundary observations. The payload or plaintext of each segment can be encrypted and the encoded segment is provided with data providing insight into the next segment of the job in question. The approach described herein enables the printer to readily retrieve a print job without pre-negotiated print segment length information. The methods described are applicable to 3D print jobs as well as 2D printing, i.e. there is provided an encryption scheme suitable for applications over and above a generic rendering task.

Compared to encrypting and then decrypting the print job as one large object, the PRinterMAC construction described herein reduces the first page out time. The construction provides: boundary hiding of print job context, which makes it difficult for attackers to observe or alter the data in a meaningful way (e.g. randomized, jobs, pages, variable, dummy segment or footer to ignore segment); IV generation in the context of print (page and job level counters); and handling of unknown length inputs/payloads (DOS protection).

According to an example, the methods described can be applicable to other rendering tasks, such as scanned jobs (i.e. scanning in the other direction client/cloud compared to printing a job), where the rendering time is reduced for the recipient due to the segmented data encryption scheme. The segmented data encryption scheme may be applied to other data streams beyond rendering tasks.

PRinterMAC enables data security of a rendering task or print job without increasing the time to first page out as the data size grows. The first page out time being reduced enhances customer experience by providing a seamless, efficient printing experience where a customer does not wait at the printer to receive their print job for too long.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

FIG. 7 shows an example of a processor 710 associated with a memory 720. The memory 720 comprises computer readable instructions 730 which are executable by the processor 710. The instructions 730 comprise:
Instructions to segment the data to form multiple variably sized segments, wherein each segment comprises a payload, and a footer portion, the footer portion comprising at least a fixed-length footer size section indicating the size of a footer encoding the size of a subsequent segment; and
Instructions to encrypt the payload of a segment using data associated with that segment and the task.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from ne example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of, any of the independent claims or other dependent claims.

1. A method for encrypting data representing a rendering task, the method comprising:
segmenting the data to form multiple variably sized segments, wherein each segment comprises:
a payload; and
a footer portion comprising at least a footer size section indicating the size of a footer encoding the size of a subsequent segment; and
encrypting each segment using data associated with that segment and the rendering task.

2. A method according to claim 1, wherein the footer portion further comprises a footer encoding the size of a subsequent segment.

3. A method according to claim 1, wherein the payload comprises plaintext.

4. A method according to claim 1, herein the footer size section has a fixed-length of one-byte.

5. A method according to claim 1, wherein the footer portion defines an amount of data to parse for each respective segment.

6. A method according to claim 1, wherein the footer is empty when the footer size section indicates that the size of the footer encoding the subsequent section is 0 or 255 bytes.

7. A method according to claim 1, wherein each segment is variably sized such that the sizes of respective segments are generated independently of other segments.

8. A method according to claim 1, wherein each segment is generated from plaintext and subsequently encrypted.

9. A method according to claim 1, wherein each segment is encrypted using a different initialisation vector.

10. A method according to claim 9, wherein each initialisation vector generated from a nonce, a message counter, and a segment counter.

11. A method according to claim 1, wherein each segment is encrypted using a different authenticated data value.

12. A method according to claim 1, wherein each se sent to a receiver separately from other segments.

13. A non-transitory machine-readable storage medium encoded with instructions executable by a processor for encrypting data representing a rendering task, the machine-readable storage medium comprising instructions to:
segment the data to form multiple variably sized segments, wherein each segment comprises:
a payload; and
a footer size section indicating the size of a footer encoding the size of a subsequent segment; and
encrypt each segment using data associated with that segment and the rendering task.

14. A storage medium according to claim 13, further comprising instructions to encrypt each segment using a different initialisation vector.

15. A storage medium according to claim 13, further comprising instructions to encrypt each segment using a different authenticated data value.
